(19) United States
(12) Patent Application Publication
(10) Pub. No.: US 2021/0098820 A1
(43) Pub. Date: Apr. 1, 2021

(54) Guiding Growth of Solid-Electrolyte Interphases via Gradient Composition

(71) Applicant: Robert Bosch GmbH, Stuttgart (DE)

(72) Inventors: John F. Christensen, Elk Grove, CA (US); Jonathan Mailoa, Cambridge, MA (US); Boris Kozinsky, Waban, MA (US); Georgy Samsonidze, San Francisco, CA (US); Mordechai Kornbluth, Brighton, MA (US)

(21) Appl. No.: 16/956,429

(22) PCT Filed: Dec. 14, 2018
(86) PCT No.: PCT/EP2018/084983

§ 371 Date: Jun. 19, 2020

Related U.S. Application Data
(60) Provisional application No. 62/609,936, filed on Dec. 22, 2017.

(51) Int. Cl. H01M 10/0562; H01M 4/38; H01M 10/052; H01M 50/417; H01M 50/434

(52) U.S. Cl. CPC H01M 10/0562; H01M 4/382; H01M 2004/027; H01M 50/417; H01M 50/434; H01M 10/052

(57) ABSTRACT

An electrolyte structure for a battery cell with a lithium metal anode has a first side configured to contact the anode and a second side facing opposite the first side. The electrolyte structure includes a first region that is adjacent to the first side and extends towards the second side and a second region disposed between the first region and the second side. The first region has a first composition of materials that is electronically insulating such that the electrolyte is stable against the lithium metal anode. The second region has a second composition of materials that is different than the first composition and has typical electrolyte properties such as mechanical strength, stability against a cathode, and ionic conductivity. The first region and the second region define a compositional gradient across a thickness of the electrolyte structure. The compositional gradient is continuum-fabricated at one point via a gradient growth method.

This application claims the benefit of U.S. Provisional Application 62/609,936, filed Dec. 22, 2017, the disclosure of which is incorporated herein by reference in its entirety.

### GOVERNMENT RIGHTS NOTICE

This invention was made with government support under DE-AR0000775 awarded by the U.S. Department of Energy, Advanced Research Projects Agency—Energy (ARPA-E). The government has certain rights in the invention.

### FIELD

The disclosure relates to batteries and more particularly to a thin film electrolyte with a gradient composition for use in batteries.

### BACKGROUND

Batteries are a useful source of stored energy that can be incorporated into a number of systems. Rechargeable lithium-ion (“Li-ion”) batteries are attractive energy storage systems for portable electronics and electric and hybrid-electric vehicles because of their high specific energy compared to other electrochemical energy storage devices. In particular, batteries with a form of lithium (“Li”) metal incorporated into the negative electrode or anode afford exceptionally high specific energy (measured in Wh/kg) and energy density (measured in Wh/L) compared to batteries with conventional carbonaceous negative electrodes.

In Li-ion battery applications with Li metal anodes, unintended side reactions occur at the electrode/electrolyte interface. This side reaction consumes the electrode material, produces a solid-electrolyte interphase (SEI) layer, and consequently reduces the battery energy capacity. However, the SEI layer often does not substantially inhibit battery operation if it satisfies two criteria: (1) the SEI layer must be a Li ionic conductor, which allows the transport of Li ions for normal battery charging/discharging operations; and (2) the SEI layer must be a poor electronic conductor, preventing electron transport across the SEI layer. In contrast, if the material is both ionically and electronically conducting, the SEI layer may grow rather than passivate. Furthermore, Li metal is sometimes unintendedly deposited on top of the SEI layer rather than below the SEI layer, potentially leading to stranded Li upon cycling.

In view of the successful use of LiPON as a thin film electrolyte in battery applications, related lithium oxides and nitrides such as LiSiO, LiSiON, LiPSiON, LiPSiBON, and others may also be useful in such applications. However, stability calculations suggest that these materials can form SEI layers that are electronically and ionically conductive, which may inhibit their use in batteries. Stability calculations are performed using the convex hull analysis in multidimensional space. For example, suppose an objective is to find the lowest-energy materials at a given composition, such as Li4SiO4. Depending on the physics, it could be that the lowest total energy is achieved by one compound (e.g. Li4SiO4) or the phase separation of multiple compounds (e.g. 2(Li2O)+SiO2).

Typically, these total-energy calculations are performed via ab-initio computations in the density-functional theory formalism. A database is constructed with many such computations, and the “convex hull” is mapped out of lowest-energy compounds or groups of compounds. Projecting any point (such as Li4SiO4) onto the convex hull will give the decomposition products that provide the lowest energy. The “formation energy” of those products is the energy cost to form those products as opposed to keep them at some other endpoints. Importantly, the actual formation of these products depends on the kinetics of the reaction and is not easily predictable. Thus, the primary use of the analysis is to determine what products could possibly form.

During the cycling of a battery, the electrochemical potential of Li will change, so to find all SEI compositions that may form, the line between the electrolyte and the Li metal is examined, and that line is projected onto the convex hull. The decomposition products (intermediate vertices along the projected line) are further examined in order to test whether any of the products are electronic conductors (metals) by computing the predicted bandgap. A zero bandgap means there is a metal, whereas a nonzero bandgap indicates a semiconductor or insulator. This determination is subject to the usual constraints and accuracy of density-functional theory, but it is expected to be reasonably reliable to predict whether LiPSiBON compounds are insulators or metals, even if the bandgap is slightly inaccurate.

FIG. 6 includes three charts that show the convex hull of LiPON, LiSiON, and LiBON compounds, respectively. The data was taken from the Materials Project, an open-source, web-based database of computed information on known and predicted materials. The data was analyzed with the MulPhaD module written by Georgy Samsonidze and plotting scripts written by Mordechai Kornbluth. The x-axis contains the composition ratio between the electrolyte and Li. The electrolyte for each line is given by the legend to the left of the plot. The y-axis contains the energy of formation in eV/atom. The curves describe the straight lines between electrolyte and Li projected onto the convex hull. The points describe the decomposition products, and are annotated by the product with the smallest bandgap, and are colored according to the magnitude of that smallest bandgap where zero bandgap (in red color) is not desirable and nonzero bandgap (in green color) is desirable.

LiPON contains products that are electronic insulators (nonzero bandgap), usually Li3P+Li3N+Li2O (not shown). Therefore, the SEI layer is an electronic insulator, leading to good performance of a LiPON electrolyte with a stable SEI layer. These characteristics enable LiPON to be useful in thin film batteries. However, LiSiO and LiBO form LiSi and LiB compounds (possibly with trace oxygenation), respectively, which are metallic. The typical decomposition may be Li5SiN3+Li2O+Li21Si5, where the last product is a metal. This characteristic poses a challenge for using LiSiO/LiBO against Li metal since the equipotential of Li on all sides of LiSi/LiB compounds will cause more LiSiO/LiBO to decompose into LiSi/LiB compounds such that the SEI layer will continuously grow.

What is needed, therefore, is a thin film electrolyte with a compositional gradient in which the side of the electrolyte that adheres to the anode has greater compositions of materials that are electronically insulating. The remainder of the electrolyte has other compositions of materials that exhibit traditional electrolyte properties, such as mechanical strength, stability against the cathode material, ionic conductivity, and others. It would be advantageous to provide the compositional gradient of the electrolyte by use of a single, gradient-producing process. A thin film electrolyte with a compositional gradient comprising multiple, independently fabricated layers of different compositions would also be advantageous.

### SUMMARY

A battery cell in one embodiment includes a positive electrode, a negative electrode that includes lithium metal, and an electrolyte structure disposed between the negative electrode and the positive electrode, the electrolyte structure including a first side configured to contact the negative electrode and a second side spaced from the first side and facing the positive electrode, the first side and the second side defining a thickness, a first region disposed adjacent to the first side and extending towards the second side, the first region having a first composition of materials that is electronically insulating, and a second region disposed between the first region and the second side, the second region having a second composition of materials that is different than the first composition, the first region and the second region defining a compositional gradient across the thickness of the electrolyte structure.

A thin film electrolyte structure for a battery cell in one embodiment includes a first side configured to contact a lithium metal anode of the battery cell and a second side facing opposite the first side, the first side and the second side defining a thickness, a first region disposed adjacent to the first side and extending towards the second side, the first region having a first composition of materials that is configured to be stable against the lithium metal anode, and a second region disposed between the first region and the second side, the second region having a second composition of materials that is different than the first composition, the first region and the second region defining a compositional gradient across the thickness of the electrolyte structure.

### BRIEF DESCRIPTION OF THE DRAWINGS

FIG. 1 depicts a simplified schematic of an electrochemical cell including a gradient composition electrolyte in a first arrangement;

FIG. 1A depicts the gradient composition electrolyte of FIG. 1 with a transition from a first region of a first composition of materials to a second region of a second composition of materials;

FIG. 2. depicts a simplified schematic of an electrochemical cell including the gradient composition electrolyte of FIG. 1 and an auxiliary electrolyte in a second arrangement;

FIG. 3 depicts a simplified schematic of an electrochemical cell including a gradient composition electrolyte in a third arrangement with the gradient composition electrolyte having multiple independent layers that are not grown in a gradient process;

FIG. 4 illustrates a process to form the gradient composition electrolytes of FIGS. 1 and 2;

FIG. 5 illustrates a process to form the gradient composition electrolyte of FIG. 3; and

FIG. 6 includes three charts that illustrate the convex hull of LiPON, LiSiON, and LiBON compounds, respectively.

### DETAILED DESCRIPTION

For the purpose of promoting an understanding of the principles of the disclosure, reference will now be made to the embodiments illustrated in the drawings and described in the following written specification. It is understood that no limitation to the scope of the disclosure is thereby intended. It is further understood that the disclosure includes any alterations and modifications to the illustrated embodiments and includes further applications of the principles of the disclosure as would normally occur to one skilled in the art to which this disclosure pertains.

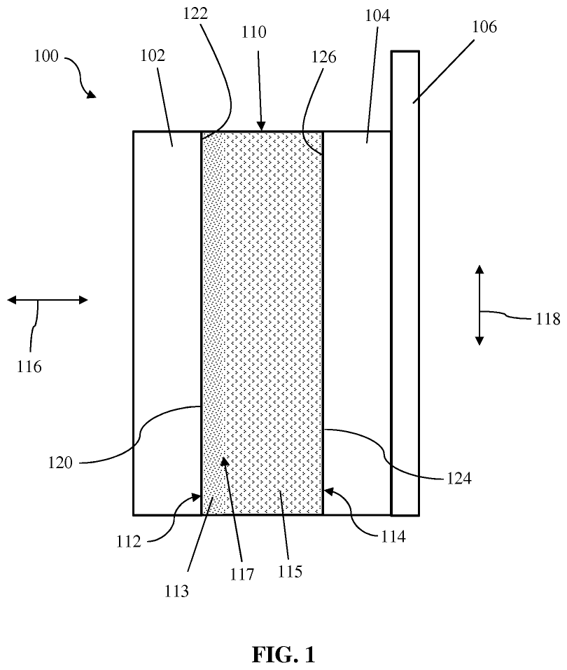

FIG. 1 depicts an electrochemical cell 100. The electrochemical cell 100 includes an anode 102, a cathode 104 with an aluminum (“Al”) current collector 106, and an electrolyte with a compositional gradient 110 (hereinafter the “gradient-composition electrolyte 110” or “GCE 110”). The anode 102, the cathode 104, the Al current collector 106, and the gradient-composition electrolyte 110 are referred to collectively as “cell components” or “components of the cell” hereinafter for efficiency. The anode 102 includes Li metal or some other Li-insertion material that can reversibly insert and extract Li ions electrochemically. The anode 102 is sized such that it has at least as much capacity as the associated cathode 104, and preferably at least 10% excess capacity and up to greater than 50% capacity in some embodiments. The Al current collector 106 is typically less than 30 μm in width and preferably less than 15 μm. In some embodiments, the Al current collector 106 has a surface treatment.

The cathode 104 includes a mixture of at least an active material and a matrix configured to conduct the primary ions of relevance to the cell 100. The active material in various embodiments includes a sulfur or sulfur-containing material (e.g., PAN-S composite or Li₂S); an air electrode; Li-insertion materials such as NCM, LiNi_{0.5}Mn_{1.5}O₄, Li-rich layered oxides, LiCoO₂, LiFePO₄, LiMn₂O₄; Li-rich NCM, NCA, and other Li intercalation materials, or blends thereof; or any other active material or blend of materials that react with and/or insert Li cations and/or electrolyte anions.

The matrix in various embodiments includes Li-conducting liquid, gel, polymer, or other solid electrolyte. Solid electrolyte materials in the cathode 104 may further include lithium conducting garnets, lithium conducting sulfides (e.g., Li₂S—P₂S) or phosphates, Li₃P, LIPON, Li-conducting polymer (e.g., polyethylene oxide (PEO) or polycaprolactone (PCL)), Li-conducting metal-organic frameworks, Li₃N, Li₃P, thio-LISiCONs, Li-conducting NaSICONs, Li₁₀GeP₂S₁₂, lithium polysulfidophosphates, or other solid Li-conducting material. Other materials in the cathode 104 may include electronically conductive additives such as carbon black, binder material, metal salts, plasticizers, fillers such as SiO₂, or the like. The cathode materials are selected to allow sufficient electrolyte-cathode interfacial area for a desired design. The cathode 104 may be greater than 1 m in thickness, preferably greater than 10 μm, and more preferably greater than 40 μm. In one embodiment, the composition of the cathode 104 includes approximately 60 to 85 weight percent active material, approximately 3 to 10 weight percent carbon additive, and 15 to 35 weight percent catholyte.

The gradient-composition electrolyte 110 in the embodiment shown in FIG. 1 has an anode side 112 and a cathode side 114 spaced from anode side 112 in a first direction 116. The anode side 112 of the gradient-composition electrolyte 110 is configured to adhere to or otherwise contact the anode 102. The cathode side 114 of the gradient-composition electrolyte 110 is configured to adhere to or otherwise contact the cathode 104. The anode side 112 of the gradient-composition electrolyte 110 defines an anode-facing surface 120 that faces an anode surface 122 of the anode 102. The cathode side 114 of the gradient-composition electrolyte 110 defines a cathode-facing surface 124 that faces a cathode surface 126 of the cathode 104.

The first direction 116 (viewed leftward or rightward in FIG. 1) corresponds generally to a respective thickness of the gradient-composition electrolyte 110 and respective thicknesses of the other cell components. A second direction 118 (viewed upward or downward in FIG. 1) corresponds generally to a respective height of the gradient-composition electrolyte 110 and respective heights of the other cell components. A third direction (not shown, but viewed perpendicular to the viewing plane of FIG. 1) corresponds generally to a respective width of the gradient-composition electrolyte 110 and respective widths of the other cell components.

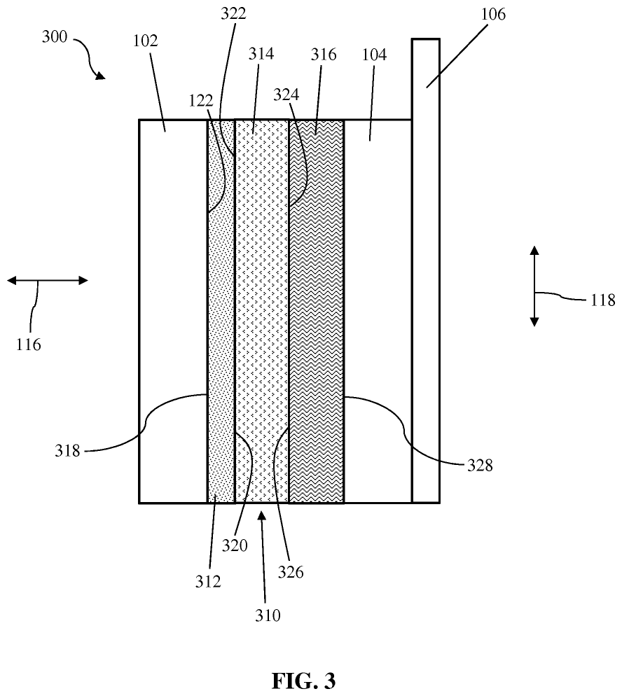

The gradient-composition electrolyte 110 of FIG. 1 generally contains one or more of lithium, silicon, phosphorous, boron, oxygen, fluorine, and nitrogen. The gradient-composition electrolyte 110 is grown via a gradient sputtering process or any other gradient-composition formation process as described below with reference to FIG. 4. These formation processes guide the growth of the anode-facing layer to a desired composition with desired properties.

The gradient-composition electrolyte 110 has greater compositions of materials that are electronically insulating on the anode-side 112 than on the cathode-side 114 so that the gradient-composition electrolyte 110 is stable against the anode 102. Such electronically insulating compositions generally include lithium, phosphorous, oxygen, fluorine, and nitrogen, which are known enhance electric resistivity. Such electronically insulating compositions more particularly include compositions that are closer to one or more of Li₃P and Li₃N. The greater compositions of materials that are electronically insulating are encompassed in a first region 113 of the gradient-composition electrolyte 110 with a thickness of about 500 nm or thinner measured from the anode-side 112. In other embodiments, the first region 113 containing the greater compositions of materials that are electronically insulating has a thickness of about 100 nm measured from the anode-side 112. As used herein, a thickness measured “from” an indicated side of an element or feature means that the thickness is measured from that indicated side in a direction of shortest extent towards the opposite of side of the element or feature. For example, since the anode side 112 and the cathode 114 side of the of the gradient-composition electrolyte 110 illustrated in FIG. 1 are roughly parallel, a thickness measured from the anode side 112 means the thickness is measured from the anode side 112 in a direction perpendicular to anode side 112 and extending towards the cathode side 114. More specifically, the thickness is measured in the first direction 116.

The gradient-composition electrolyte 110 has a second region 115 starting from an approximate end or boundary of the first region 113 and moving away from the anode 102 in the first direction 116 towards the cathode side 114. In the second region 115, the gradient-composition electrolyte 110 has other compositions that exhibit more typical electrolyte properties, such as mechanical strength, stability against the cathode material, ionic conductivity, and other properties. The thickness of the second region 115 of the gradient-composition electrolyte 110 varies depending on the thickness of the first region 113 and the total thickness of the gradient-composition electrolyte 110. For instance, in an embodiment of the gradient-composition electrolyte 110 with a total thickness of 5,000 nm and a first region 113 thickness of 500 nm, the second region 115 will have a thickness of approximately 4,500 nm. In another embodiment of the gradient-composition electrolyte 110 with a total thickness of 25,000 nm and a first region 113 thickness of 100 nm, the second region 115 will have a thickness of approximately 24,000 nm. In the embodiment of FIG. 1, the gradient-composition electrolyte 110 is the primary and sole electrolyte and separator.

In the gradient-composition electrolyte 110 shown in FIG. 1, the compositional gradient from the anode side 112 to the cathode side 114 is discrete through a transition 117 from the first region to the second region such that the quantity of a given material composition in one region changes abruptly and distinctly for a given increment in the first direction to another region. In other embodiments of the gradient-composition electrolyte 110 such as that shown in FIG. 1A, the compositional gradient from the anode side 112 to the cathode side 114 is smooth, continuous, and/or gradual through the transition 117 from the first region to the second region.

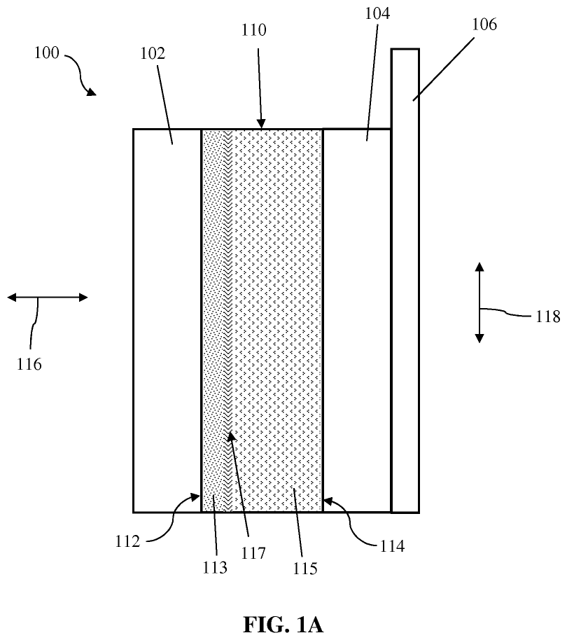

FIG. 2 depicts an electrochemical cell 200. The cell 200 is similar to the cell 100 of FIG. 1 in that the cell 200 includes the anode 102, the cathode 104 with the Al current collector 106, and a gradient-composition electrolyte 210. The cell 200 also includes an auxiliary electrolyte 211 disposed between the gradient-composition electrolyte 210 and the cathode 104. The gradient-composition electrolyte 210 of FIG. 2 is essentially identical to the gradient-composition electrolyte 110 of FIG. 1. The gradient-composition electrolyte 210 has an anode side 212 that is configured to adhere to or otherwise contact the anode 102. The anode side 212 defines an anode-facing surface 220 that faces the anode surface 122 of the anode 102. A first region 213 of the gradient-composition electrolyte 210 includes greater compositions of materials that are electronically insulating. The first region 213 is disposed adjacent to the anode side 212.

One difference between the cell 100 and the cell 200 is that the gradient-composition electrolyte 210 has an auxiliary side 214 that is configured to adhere to or otherwise contact the auxiliary electrolyte 211. The auxiliary side 214 of the gradient-composition electrolyte 210 defines an auxiliary-facing surface 224 that faces an auxiliary surface 226 of the auxiliary electrolyte 211. The gradient-composition electrolyte 210 has a second region 215 disposed between the first region 213 and the auxiliary side. In the second region 215, the gradient-composition electrolyte 210 has other compositions that exhibit more typical electrolyte properties, such as mechanical strength, stability against the cathode material, ionic conductivity, and other properties. Another difference between the cell 100 and the cell 200 is that the total thickness of the gradient-composition electrolyte 210 is approximately 1,000 to 5,000 nm, which is smaller than the total thickness of the gradient-composition electrolyte 110 of FIG. 1.

The auxiliary electrolyte 211 is configured to have high ionic conductivity. The thickness of the auxiliary electrolyte 211 is in the range of 10 to 20 μm. The auxiliary electrolyte 211 in one embodiment is configured as a liquid electrolyte in pores of conventional polyolefin separator. The auxiliary electrolyte 211 in another embodiment is configured as a polymer separator. In yet another embodiment, the auxiliary electrolyte 211 is configured as a ceramic separator such as sulfide with approximately 1e-3 S/cm or higher.

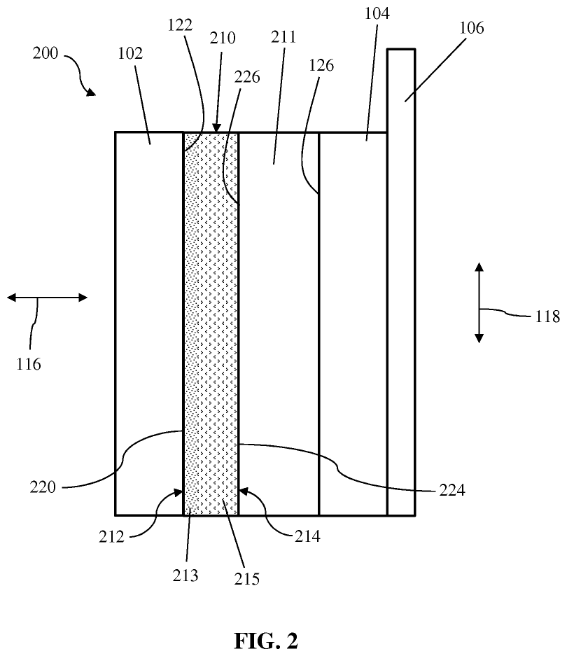

FIG. 3 depicts an electrochemical cell 300 with an alternative gradient-composition electrolyte 310. The cell 300 is similar to the cell 100 (FIG. 1) and the cell 200 (FIG. 2) in that the cell 300 includes the anode 102, the cathode 104 with the Al current collector 106, and a gradient-composition electrolyte 310. One difference in the cell 300 is that the gradient-composition electrolyte 310 includes multiple independent layers that are not grown in a single gradient process. The gradient-composition electrolyte 310 includes a first layer 312 positioned adjacent to the anode 102, a second layer 314 positioned adjacent to the first layer 312, and a third layer 316 positioned adjacent to and between the second layer 314 and the cathode 104.

The first layer 312 has a first anode-facing side 318 and a first cathode-facing side 320 spaced from the first anode-facing side 318 in the first direction. The first anode-facing side 318 of the gradient-composition electrolyte 310 is configured to adhere to or otherwise contact the anode 102. The second layer 314 has a second anode-facing side 322 and a second cathode-facing side 324 spaced from the second anode-facing side 322 in the first direction. The second anode-facing side 322 of the second layer 314 is configured to adhere to or otherwise contact the first cathode-facing side 320 of the first layer 312. The third layer 316 has a third anode-facing side 326 and a third cathode-facing side 328 spaced from the third anode-facing side 326 in the first direction. The third anode-facing side 326 of the third layer 316 is configured to adhere to or otherwise contact the second cathode-facing side 324 of the second layer 314. The third cathode-facing side 328 of the third layer 316 is configured to adhere to or otherwise contact the cathode 104.

The first layer 312 has a thickness of approximately 50 nm and contains LiPON or another electrolyte that has relatively poor ionic conductivity (i.e., approximately 1e-6 S/cm) and resistivity of approximately 5 Ωcm² and desirable properties for an SEI such as electronic resistivity. The second layer 314 has a thickness of approximately 0.5 μm and contains LiSiPON or another glass that is electronically conducting but has moderate ionic conductivity (i.e., approximately 1e-5 S/cm) and resistivity of 5 Ωcm². The third layer 316 has a thickness of approximately 20 μm and constitutes a separator with high-conductivity. The third layer 316 in one embodiment is configured as a liquid electrolyte in pores of conventional polyolefin separator. The third layer 316 in another embodiment is configured as a polymer separator. In yet another embodiment, the third layer 316 is configured as a ceramic separator such as sulfide with approximately 1e-3 S/cm or higher and resistivity of 2 Ωcm². Assuming negligible interfacial impedance, the entire gradient-composition electrolyte 310 has a resistivity of approximately 12 Ωcm².

FIG. 4 depicts a process 400 of forming the gradient-composition electrolyte 110 of FIG. 1 or the gradient-composition electrolyte 210 of FIG. 2. A first region of a gradient-composition electrolyte 110, 210 is formed using a gradient sputtering process, such as disclosed in Maibach et al., J. Phys. Chem. Lett. 2016 https://dx.doi.org/10.1021/acs.jplett.6b00391 and Phuoc and Ong, IEEE Trans. Mag. 2014 https://doi.org/10.1109/TMAG.2013.2296936, or a similar gradient-composition forming process (block 402). The first region contains a first composition of materials that in some embodiments includes one or more of lithium, phosphorous, oxygen, fluorine, and nitrogen. The first composition of materials is electronically insulating and in some embodiments includes compositions that are closer to one or both of Li₃P and Li₃N. A second region of the gradient-composition electrolyte 110, 210 is then continuum-fabricated on the first region using the gradient sputtering process or the similar gradient-composition forming process (block 404). The second region contains a second composition of materials that has compositions that exhibit typical electrolyte properties, such as mechanical strength, stability against the cathode material, ionic conductivity, and other properties.

The process 400 has a number of technical advantages: (1) It is expected to be easier and cheaper to produce the gradient-composition electrolyte than multiple layers of electrolyte stacked upon each other, because the entire electrolyte is grown with a single process. (2) The anode-facing layer has a composition and thickness than can be controlled easier than a naturally-forming SEI layer. (3) The adhesion between different parts of the electrolyte is expected to be better (causing lower interfacial resistance) because they are grown as one unit.

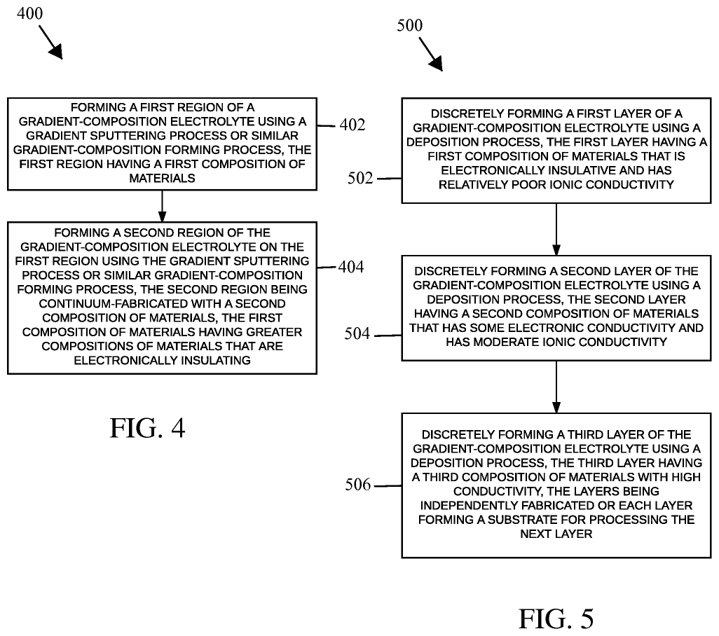

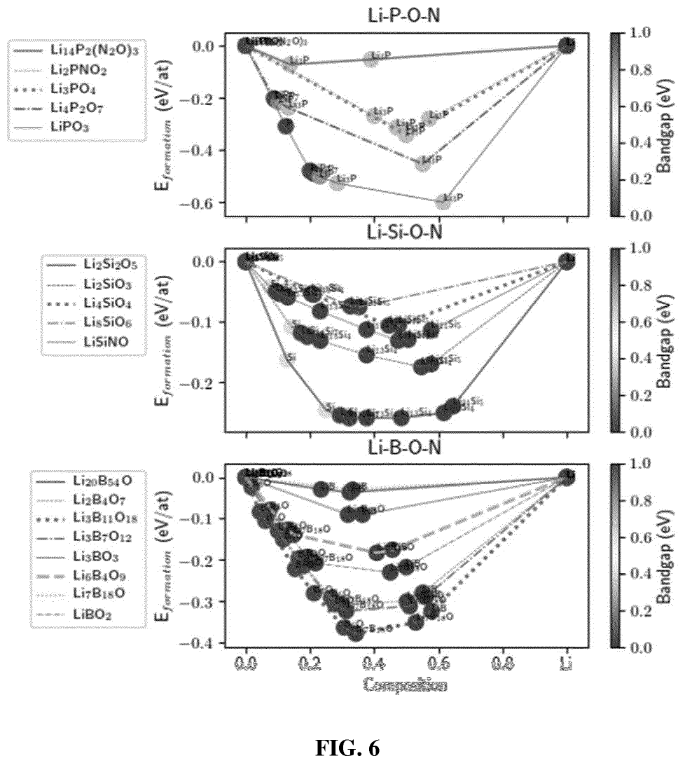

FIG. 5 depicts a process 500 of forming the gradient-composition electrolyte 310 of FIG. 3. A first layer of a gradient-composition electrolyte 310 is discretely formed using a deposition process (block 502). The first layer has a first composition of materials that is electronically insulative and has relatively poor ionic conductivity. A second layer of the gradient-composition electrolyte 310 is discretely formed using the deposition process (block 504). The second layer has a second composition of materials that has some electronic conductivity and has moderate ionic conductivity. A third layer of the gradient-composition electrolyte 310 is discretely formed using the deposition process (block 506). The gradient-composition electrolyte 310 is formed by stacking the first layer, the second layer, and the third layer upon each other. In one embodiment of the process 500, the layers are independently fabricated and then attached with a joining process. In another embodiment of the process 500, each layer forms a substrate for processing of the next layer.

The gradient-composition electrolyte disclosed herein as well as batteries and devices which include the gradient-composition electrolyte can be embodied in a number of different types and configurations. The following embodiments are provided as examples and are not intended to be limiting.

Embodiment 1: An electrolyte with a compositional gradient (henceforth GCE, gradient-composition electrolyte), where one side has the property of being stable against a Li-metal anode, and the rest has other desired properties such as mechanical strength and ionic conductivity.

Embodiment 2: Where the GCE contains any or all of: lithium, silicon, phosphorous, boron, oxygen, nitrogen, and fluorine.

Embodiment 3: Where some or all of the GCE is fabricated via sputtering.

Embodiment 4: Where the compositional gradient is continuum-fabricated at one point (such as a substrate surface) via a gradient-growth method, such as gradient sputtering.

Embodiment 5: Where the compositional gradient is discrete, formed by stacking multiple electrolyte layers upon each other, whether independently fabricated or by each layer forming a substrate for processing the next layer.

Embodiment 6: Where the entire GCE is placed upon another supporting structure; or is directly applied to the cathode.

Embodiment 7: Where the GCE next to the anode contains any or all of: lithium, phosphorous, oxygen, fluorine, and nitrogen; which are known enhance electric resistivity.

Embodiment 8: Where the electronically-insulating component of the GCE (anode-facing layer) has thickness of 500 nm or less, and ideally less than 100 nm.

Embodiment 9: Where the sputtered part of the GCE is 5 μm or less, and ideally less than 1 μm.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A battery cell, comprising:
a positive electrode;
a negative electrode that includes lithium metal; and
an electrolyte structure disposed between the negative electrode and the positive electrode, the electrolyte structure including:
a first side configured to contact the negative electrode and a second side spaced from the first side and facing the positive electrode, the first side and the second side defining a thickness,
a first region disposed adjacent to the first side and extending towards the second side, the first region having a first composition of materials that is electronically insulating, and
a second region disposed between the first region and the second side, the second region having a second composition of materials that is different than the first composition, the first region and the second region defining a compositional gradient across the thickness of the electrolyte structure.

2. The battery cell of claim 1, wherein the compositional gradient of the electrolyte structure is continuum-fabricated at one point via a gradient-growth process.

3. The battery cell of claim 1, wherein a transition from the first composition of the first region to the second composition of the second region is one or more of smooth, continuous, and gradual.

4. The battery cell of claim 1, wherein a transition from the first composition of the first region to the second composition of the second region is discrete.

5. The battery cell of claim 1, wherein the second side of the electrolyte structure is configured to contact the positive electrode.

6. The battery cell of claim 1, further comprising an auxiliary electrolyte disposed between the electrolyte structure and the positive electrode, wherein the second side of the electrolyte structure is configured to contact the auxiliary electrolyte, and wherein the auxiliary electrolyte has an ionic conductivity that is greater than or equal to an ionic conductivity of the second composition.

7. The battery cell of claim 6, wherein the auxiliary electrolyte is one of a liquid electrolyte in pores of a polyolefin separator, a polymer separator, or a ceramic separator.

8. The battery cell of claim 6, wherein the thickness of the electrolyte structure is in a range of 1 to 5 microns between the first and second sides, and wherein the auxiliary electrolyte has a thickness in a range of 10 to 20 microns between the electrolyte structure and the positive electrode.

9. The battery cell of claim 1, wherein the first region includes one or more of lithium, phosphorous, oxygen, and nitrogen.

10. The battery cell of claim 1, wherein:
the electrolyte structure includes a third region disposed between the second region and the second side, the third region having a third composition of materials that is different than the first composition and the second composition, and
the first region, the second region, and the third region are discrete regions that are stacked one upon the other and define the compositional gradient.

11. The battery cell of claim 10, wherein:
the first region has a thickness of approximately 50 nanometers and the first composition is an electronically-insulating glass,
the second composition is a glass having an ionic conductivity that is greater than an ionic conductivity of the first composition, and
the third composition has an ionic conductivity that is greater than the ionic conductivity of the second composition.

12. A thin film electrolyte structure for a battery cell, comprising:
a first side configured to contact a lithium metal anode of the battery cell and a second side facing opposite the first side, the first side and the second side defining a thickness of the electrolyte structure;
a first region disposed adjacent to the first side and extending towards the second side, the first region having a first composition of materials that is configured to be stable against the lithium metal anode; and
a second region disposed between the first region and the second side, the second region having a second composition of materials that is different than the first composition, the first region and the second region defining a compositional gradient across the thickness of the electrolyte structure.

13. The electrolyte structure of claim 12, wherein the first composition of materials is electronically insulating and the second composition of materials has a conductivity that is greater than a conductivity of the first composition.

14. The electrolyte structure of claim 12, wherein the compositional gradient includes one or more of lithium, silicon, phosphorous, boron, oxygen, and nitrogen.

15. The electrolyte structure of claim 12, wherein the first region includes one or more of lithium, phosphorous, oxygen, and nitrogen.

16. The electrolyte structure of claim 12, wherein the first region has a first thickness of 500 nanometers or less measured from the first side, and wherein the thickness of the electrolyte structure is in a range of 5 to 25 microns.

17. The electrolyte structure of claim 12, wherein the compositional gradient is continuum-fabricated at one point via a gradient-growth process.

18. The electrolyte structure of claim 12, wherein a portion of the compositional gradient is formed via sputtering, the sputtered portion having a thickness of 5 microns or less.

19. The electrolyte structure of claim 13, further comprising a third region disposed between the second region and the second side, the third region having a third composition of materials that is different than the first composition and the second composition,
wherein the first region, the second region, and the third region are discrete regions that are stacked one upon the other and define the compositional gradient.

20. The electrolyte structure of claim 19, wherein the third composition has a conductivity that is greater than the conductivity of the second composition.
